(19) United States
(12) Patent Application Publication
(10) Pub. No.: US 2026/0214478 A1
(43) Pub. Date: Jul. 23, 2026

(54) NETWORK TEST DEVICE AND TEST METHOD THEREOF

(71) Applicant: ANRITSU CORPORATION, Kanagawa (JP)

(72) Inventors: Junya ODA, Kanagawa (JP); Saaya CHIBA, Kanagawa (JP)

(21) Appl. No.: 19/439,549

(22) Filed: Jan. 5, 2026

(30) Foreign Application Priority Data
Jan. 23, 2025 (JP) 2025-009841
Mar. 5, 2025 (JP) 2025-034486

(51) Int. Cl. H04W 24/08

(52) U.S. Cl. CPC H04W 24/08

(57) ABSTRACT

In a downlink test, a network test device connected to a wireless terminal connected to a communication network via a base station causes the wireless terminal to periodically transmit a measurement packet to a network test device as a server, and in a case where the measurement packet is received from the wireless terminal, the network test device detects an address of a transmission source of the measurement packet and transmits the measurement packet to the address.

### TECHNICAL FIELD

The present invention relates to a network test device that tests network performance of a wireless terminal that performs mobile communication using a mobile communication system.

### BACKGROUND ART

A network test device tests whether or not network performance such as a throughput and a delay of a wireless terminal (user equipment (UE)) that performs mobile communication using a mobile communication system meets desired performance.

Patent Document 1 discloses that, in a test system of a mobile communication terminal device in which a plurality of pseudo base station devices and a server are connected to a network via a relay device to check a communication state between the mobile communication terminal device and the server, control is performed such that only the pseudo base station device with which the mobile communication terminal device is in communication responds to an address resolution request of an address resolution device, and even in a case where the pseudo base station device to which the mobile communication terminal device is connected is changed due to a handover or the like, communication between the mobile communication terminal device and the server can be maintained.

### RELATED ART DOCUMENT

### Patent Document

[Patent Document 1] Japanese Patent No. 5600720

### DISCLOSURE OF THE INVENTION

### Problem that the Invention is to Solve

Meanwhile, since the test system disclosed in Patent Document 1 includes the pseudo base station device, the pseudo base station device that performs communication using the address resolution device can be switched by setting whether or not to respond to the address resolution request of the address resolution device, but cannot be applied in a case where network performance of a wireless terminal is tested by using a commercial base station.

Therefore, in a case where an address of the wireless terminal is changed due to a handover or the like, a packet from the server to the wireless terminal is not delivered, and measurement is not possible or measurement is interrupted.

Therefore, an object of the present invention is to provide a network test device that can maintain communication even in a case where an address of a wireless terminal is changed in a case of testing network performance of the wireless terminal using a mobile communication system.

In addition, since the test system described in Patent Document 1 includes the pseudo base station device, the pseudo base station device that performs communication using the address resolution device can be switched by setting whether or not to respond to the address resolution request of the address resolution device. Meanwhile, in a case where the network performance of the wireless terminal is tested using the commercial base station, the address of the wireless terminal in the mobile communication system is assigned by the mobile communication system. Therefore, the address assigned to the wireless terminal must be checked each time the test is performed, and test efficiency is poor.

Therefore, an object of the present invention is to provide a network test device that can perform a test without checking an address of a wireless terminal in a case where network performance of the wireless terminal is tested using a mobile communication system.

### Means for Solving the Problem

According to the present invention, there is provided a network test device (1a, 1b, 1c, 1d) that tests network performance of a wireless terminal (100) connected to a communication network (102) via a base station (101), the network test device including: a control unit (14) that causes the wireless terminal connected to the communication network to transmit a measurement packet including an address of a transmission source.

In addition, in the network test device according to the present invention, the control unit of the network test device (1a) causes the wireless terminal to periodically transmit the measurement packet to a server connected to the communication network, for testing a downlink, which is a flow of a packet from the server to the wireless terminal.

With this configuration, in the downlink test, the measurement packet is periodically transmitted from the wireless terminal to the server. Therefore, even in a case where an IP address of the wireless terminal on the communication network side is changed, the server side can know the IP address of the wireless terminal on the communication network side, and the communication can be maintained even in a case where the IP address of the wireless terminal on the communication network side is changed.

In addition, in the network test device according to the present invention, the control unit of the network test device (1a) detects that an address of the wireless terminal on a communication network side is changed, and causes the wireless terminal to transmit the measurement packet to the server only upon the detection.

With this configuration, the measurement packet is transmitted from the wireless terminal to the server only in a case where the address of the wireless terminal on the communication network side is changed. Therefore, it is possible to efficiently notify the server side that the IP address of the wireless terminal on the communication network side is changed, and it is possible to maintain the communication even in a case where the IP address of the wireless terminal on the communication network side is changed.

In addition, in the network test device according to the present invention, in a case where an uplink, which is a flow of a packet from the wireless terminal to the server, and the downlink are simultaneously tested, the control unit of the network test device (1a) causes the wireless terminal not to transmit the periodic measurement packet.

With this configuration, in a case where the uplink and the downlink are simultaneously measured, the transmission of the periodic measurement packet is not performed. Therefore, even in a case where the transmission of the measurement packet is not performed periodically, it is possible to notify the server side of the change in the IP address of the wireless terminal on the communication network side, and it is possible to maintain the communication even in a case where the IP address of the wireless terminal on the communication network side is changed.

In addition, in the network test device according to the present invention, in a case where the measurement packet is received from the wireless terminal, the control unit of the network test device (1b) detects the address of the transmission source of the measurement packet, and transmits the measurement packet to the address.

With this configuration, the measurement packet is transmitted to the IP address of the transmission source of the measurement packet received from the wireless terminal. Therefore, even in a case where the IP address of the wireless terminal on the communication network side is changed, the communication can be maintained.

In addition, in the network test device according to the present invention, in a case where a change in the address of the transmission source of the received measurement packet is detected, the control unit of the network test device (1b) changes a destination address of the measurement packet to be transmitted.

With this configuration, in a case where there is a change in the IP address of the transmission source of the measurement packet received from the wireless terminal, a destination IP address of the measurement packet to be transmitted is changed. Therefore, it is possible to efficiently change the destination IP address of the measurement packet, and it is possible to maintain the communication even in a case where the IP address of the wireless terminal on the communication network side is changed.

In addition, in the network test device according to the present invention, in a case where the measurement packet is received from the wireless terminal, the control unit of the network test device (1d) detects the address of the transmission source of the measurement packet, and starts a test of a downlink, which is a flow of a packet from the network test device to the wireless terminal, by starting transmission of the measurement packet to the address.

With this configuration, in a case where the measurement packet is received from the wireless terminal, the measurement packet is transmitted to the address of the transmission source of the received measurement packet, and the downlink test is started. Therefore, the test can be performed without checking the address of the wireless terminal.

In addition, in the network test device according to the present invention, in a case where an uplink, which is a flow of a packet from the wireless terminal to the network test device, and the downlink are simultaneously tested, and a change in the address of the transmission source of the received measurement packet is detected, the control unit of the network test device (1d) changes a destination address of the measurement packet to be transmitted.

With this configuration, in a case where there is a change in the address of the transmission source of the measurement packet received from the wireless terminal, the destination address of the measurement packet to be transmitted is changed, and even in a case where the address of the wireless terminal on the communication network side is changed, it is possible to maintain the communication.

In addition, in the network test device according to the present invention, the control unit of the network test device (1c) causes the wireless terminal to transmit the measurement packet to a server connected to the communication network at a start of testing a downlink, which is a flow of a packet from the server to the wireless terminal.

With this configuration, the measurement packet is transmitted to the server at the start of the measurement of the downlink. Therefore, the server that receives the measurement packet can know the address of the wireless terminal, and the test can be performed without checking the address of the wireless terminal.

In addition, in the network test device according to the present invention, in a case where an uplink, which is a flow of a packet from the wireless terminal to the server, and a downlink are simultaneously tested, the control unit of the network test device (1c) starts measurement by starting transmission of the measurement packet for uplink measurement.

With this configuration, in a case where the uplink and the downlink are simultaneously tested, the test is started by transmitting the measurement packet from the network test device. Therefore, the server that receives the measurement packet for the uplink test can know the address of the wireless terminal, and the test can be performed without checking the address of the wireless terminal.

According to the present invention, there is provided a network test method using a network test device (1a, 1b, 1c, 1d) that tests network performance of a wireless terminal (100) connected to a communication network (102) via a base station (101), the network test method including: a step of causing the wireless terminal connected to the communication network to transmit a measurement packet.

In addition, the network test method using the network test device (1c) according to the present invention, further includes: a step of causing the wireless terminal to periodically transmit the measurement packet to a server connected to the communication network, for testing a downlink, which is a flow of a packet from the server to the wireless terminal.

With this configuration, in the downlink test, the measurement packet is periodically transmitted from the wireless terminal to the server. Therefore, even in a case where an IP address of the wireless terminal on the communication network side is changed, the server side can know the IP address of the wireless terminal on the communication network side, and the communication can be maintained even in a case where the IP address of the wireless terminal on the communication network side is changed.

In addition, in the network test method according to the present invention, it is detected that an address of a wireless terminal on a communication network side is changed, and the wireless terminal is caused to transmit the measurement packet to the server only upon the detection.

In addition, in the network test method according to the present invention, in a case where an uplink, which is a flow of a packet from the wireless terminal to the server, and the downlink are simultaneously tested, the wireless terminal is caused not to transmit the periodic measurement packet.

In addition, the network test method using the network test device (1d) according to the present invention, further includes: a step of detecting, in a case where the measurement packet is received from the wireless terminal, the address of the transmission source of the measurement packet, and transmitting the measurement packet to the address.

With this configuration, the measurement packet is transmitted to the IP address of the transmission source of the measurement packet received from the wireless terminal. Therefore, even in a case where the IP address of the wireless terminal on the communication network side is changed, the communication can be maintained.

In addition, the network test method using the network test device (1d) according to the present invention, further includes: a step of detecting, in a case where the measurement packet is received from the wireless terminal, the address of the transmission source of the measurement packet, and starting a test of a downlink, which is a flow of a packet from the network test device to the wireless terminal, by starting transmission of the measurement packet to the address.

With this configuration, in a case where the measurement packet is received from the wireless terminal, the measurement packet is transmitted to the address of the transmission source of the received measurement packet, and the downlink test is started. Therefore, the test can be performed without checking the address of the wireless terminal.

In addition, in the network test method according to the present invention, in a case where an uplink, which is a flow of a packet from the wireless terminal to the network test device, and the downlink are simultaneously tested, and a change in the address of the transmission source of the received measurement packet is detected, a destination address of the measurement packet to be transmitted is changed.

In addition, in the network test method according to the present invention, the wireless terminal is caused to transmit the measurement packet to a server connected to the communication network at a start of testing a downlink, which is a flow of a packet from the server to the wireless terminal.

In addition, in the network test method according to the present invention, in a case where an uplink, which is a flow of a packet from the wireless terminal to the server, and a downlink are simultaneously tested, the control unit of the network test device (1c) starts measurement by starting transmission of the measurement packet for uplink measurement.

### Advantage of the Invention

The present invention can provide a network test device that can maintain communication even in a case where an address of a wireless terminal is changed in a case where network performance of the wireless terminal is tested using a mobile communication system.

In addition, the present invention can provide a network test device that can perform a test without checking an address of a wireless terminal in a case where a network performance of the wireless terminal is tested using a mobile communication system.

### BRIEF DESCRIPTION OF THE DRAWINGS

FIG. 1 is a block diagram of a network test device according to an embodiment of the present invention.

FIG. 2 is a schematic configuration diagram illustrating an example of a test method of the network test device according to the embodiment of the present invention.

FIGS. 3A and 3B FIG. 3A is a flowchart describing a procedure of a measurement packet periodic-transmission process of the network test device according to the embodiment of the present invention. FIG. 3B is a flowchart describing a procedure of a downlink measurement start process of the network test device according to the embodiment of the present invention.

FIG. 4 is a flowchart describing a procedure of a measurement packet transmission destination detection process of the network test device according to the embodiment of the present invention.

### BEST MODE FOR CARRYING OUT THE INVENTION

### First Embodiment

Hereinafter, a network test device according to an embodiment of the present invention will be described in detail with reference to the drawings.

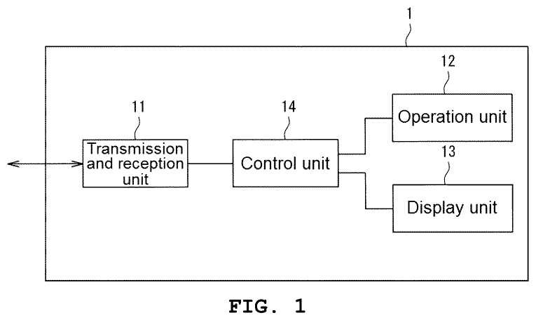

In FIG. 1, a network test device 1 according to an embodiment of the present invention is configured with a transmission and reception unit 11, an operation unit 12, a display unit 13, and a control unit 14.

The transmission and reception unit 11 transmits and receives a packet to and from a device connected by wire or the like according to a predetermined communication standard. The transmission and reception unit 11 transmits the received packet to the control unit 14. The transmission and reception unit 11 transmits a packet created by the control unit 14 according to a predetermined communication standard.

The operation unit 12 is configured with an input device such as a keyboard, a mouse, and a touch panel, and outputs information or the like input by an operation to the control unit 14.

The display unit 13 is configured with an image display device, such as a liquid crystal display, and displays an image for inputting information required for measurement, an image indicating a measurement result, or the like.

The control unit 14 is configured with a computer unit including a central processing unit (CPU), a random access memory (RAM), a read only memory (ROM), a hard disk device, and an input and output port (not illustrated).

The ROM and the hard disk device of this computer unit store various control constants, various maps, and the like, as well as a program for causing the computer unit to function as the control unit 14. That is, the computer unit functions as the control unit 14 by the CPU executing the program stored in the ROM and the hard disk device. The hard disk device may be a compact flash (CF) card or the like using a flash memory.

The transmission and reception unit 11, the operation unit 12, and the display unit 13 are connected to the input and output port of the control unit 14, and the control unit 14 and each unit can transmit and receive a signal.

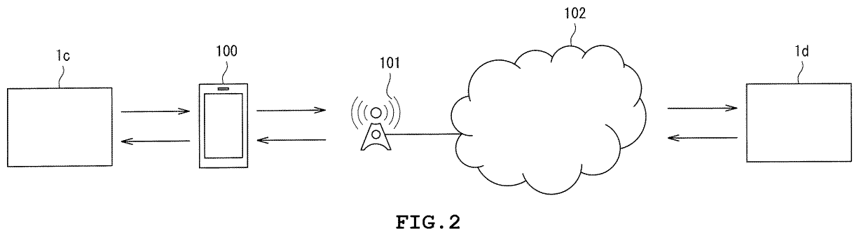

In the present example, in the same manner as a network test device 1a in FIG. 2, the network test device 1 in FIG. 1 is connected to a wireless terminal 100, which is a device under test (DUT), and causes the wireless terminal 100 to transmit and receive a packet to and from a server connected to a communication network 102 via a base station 101 for testing network performance of the wireless terminal 100.

The network test device 1a causes the wireless terminal 100 to transmit the packet to the server by using, for example, a tethering function of the wireless terminal 100.

In addition, in the same manner as a network test device 1b in FIG. 2, the network test device 1 in FIG. 1 can also function as a server facing the wireless terminal 100, and can be connected to the communication network 102 to transmit and receive a packet to and from the wireless terminal 100.

The network test device 1a measures a throughput, a delay, or the like of a downlink, which is a flow of the packet from the server to the wireless terminal 100.

The network test device 1b measures, for example, a throughput, a delay, or the like of an uplink, which is a flow of the packet from the wireless terminal 100 to the server.

At the time of measurement, the measurement packet is transmitted by designating an address of a destination in advance, for example, an Internet Protocol (IP) address. The IP address is an IP address in the communication network 102. In a case where communication is performed between the network test device 1a and the wireless terminal 100 by using an IP address, communication is performed by using an IP address distinguished from the IP address.

In a case where the network test device 1a transmits the packet to the designated IP address of the server, the packet reaches the server through the wireless terminal 100. In this case, a transmission source of the packet is an IP address of the wireless terminal 100 on the communication network 102 side. That is, the wireless terminal 100 rewrites the IP address of the transmission source, and the IP address of the wireless terminal 100 on the communication network 102 side is transmitted to the server as the transmission source.

In a case where the network test device 1b transmits the packet to the designated IP address of the wireless terminal 100, the packet reaches the network test device 1a through the wireless terminal 100. That is, the wireless terminal 100 rewrites a destination IP address, and the packet is transmitted to the network test device 1b.

In such a case, in a case where a handover is performed by a multi-mobile network operator (MNO) or the like, the IP address of the wireless terminal 100 on the communication network 102 side is changed, the transmission destination of the measurement packet from the server is unknown, and the measurement packet is not delivered.

The IP address of the wireless terminal 100 on the communication network 102 side is changed in a case of the handover for switching the base station 101, switching of a carrier of a multi-MNO, or the like.

In the multi-MNO, any of the base stations 101 of a plurality of carriers is connected such that a radio wave is not interrupted, but the IP address on the communication network 102 side of the wireless terminal 100 is changed in a case where the carrier is switched.

In a case where the downlink measurement is being performed, the control unit 14 of the network test device 1a of the present example periodically transmits the measurement packet to the server via the wireless terminal 100. Therefore, a measurement packet having the IP address on the communication network 102 side of the wireless terminal 100 as a transmission source is transmitted to the server.

In a case where the measurement packet is received from the wireless terminal 100, the control unit 14 of the network test device 1b as the server detects the IP address of the transmission source, which is an IP address of the wireless terminal 100 on the communication network 102 side, and transmits the measurement packet to the IP address.

The control unit 14 of the network test device 1a may detect that the IP address of the wireless terminal 100 on the communication network 102 side is changed, and may cause the wireless terminal 100 to transmit the measurement packet to the server only at that time.

In a case where the control unit 14 of the network test device 1b detects that the IP address of the transmission source of the received measurement packet is changed, the control unit 14 may change the destination IP address of the measurement packet to be transmitted.

In a case where the uplink and the downlink are being simultaneously measured, the control unit 14 of the network test device 1a does not transmit a periodic measurement packet.

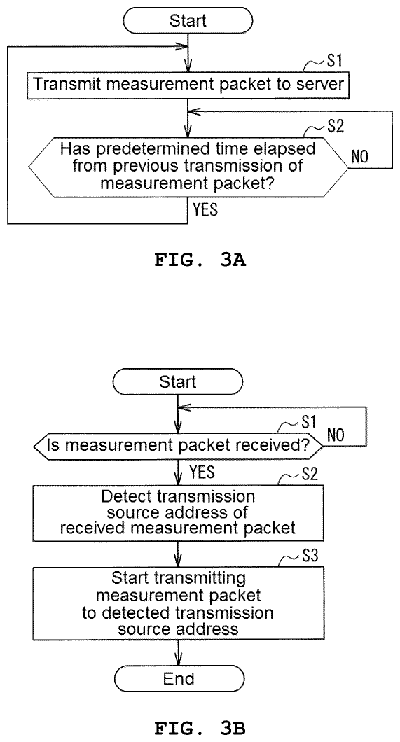

A measurement packet periodic-transmission process by the network test device 1a according to the present embodiment configured as described above will be described with reference to FIG. 3A. The measurement packet periodic-transmission process to be described below is started in a case where downlink measurement is started.

In step S1, the control unit 14 of the network test device 1a transmits a measurement packet to the network test device 1b as a server. After the process in step S1 is executed, the control unit 14 of the network test device 1a executes a process in step S2.

In step S2, the control unit 14 of the network test device 1a determines whether or not a predetermined time elapses from the previous transmission of the measurement packet.

In a case where it is determined that the predetermined time elapses from the transmission of the previous measurement packet, the control unit 14 of the network test device 1a executes the process in step S1. In a case where it is determined that the predetermined time does not elapse from the transmission of the previous measurement packet, the control unit 14 of the network test device 1a executes the process in step S2.

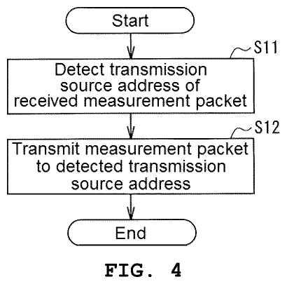

A measurement packet transmission destination detection process by the network test device 1b according to the present embodiment will be described with reference to FIG. 4. The measurement packet transmission destination detection process to be described below is started in a case where downlink measurement is started.

In step S11, the control unit 14 of the network test device 1b detects a transmission source address of a received measurement packet. After the process in step S11 is executed, the control unit 14 of the network test device 1b executes a process in step S12.

In step S12, the control unit 14 of the network test device 1b transmits the measurement packet in which the detected transmission source address is set to the transmission destination address. After executing the process in step S12, the control unit 14 of the network test device 1b ends the measurement packet transmission destination detection process.

As described above, in the embodiment described above, in a case where the measurement of the downlink is being performed, the control unit 14 of the network test device 1a causes the wireless terminal 100 to periodically transmit the measurement packet to the server.

Therefore, even in a case where the measurement packet is periodically transmitted from the wireless terminal 100 to the server during the downlink measurement and the IP address on the communication network 102 side of the wireless terminal 100 is changed, the server side can know the IP address on the communication network 102 side of the wireless terminal 100, and the communication can be maintained even in a case where the IP address on the communication network 102 side of the wireless terminal 100 is changed.

In addition, the control unit 14 of the network test device 1a detects that the IP address of the wireless terminal 100 on the communication network 102 side is changed, and causes the wireless terminal 100 to transmit the measurement packet to the server only at that time.

Therefore, the measurement packet is transmitted from the wireless terminal 100 to the server only in a case where the IP address on the communication network 102 side of the wireless terminal 100 is changed, and it is possible to efficiently notify the server side of the change in the IP address on the communication network 102 side of the wireless terminal 100, and to maintain the communication even in a case where the IP address on the communication network 102 side of the wireless terminal 100 is changed.

In addition, in a case where the uplink and the downlink are being simultaneously measured, the control unit 14 of the network test device 1a does not transmit the periodic measurement packet.

Therefore, in a case where the uplink and the downlink are simultaneously measured, the server side can be notified of the change in the IP address of the wireless terminal 100 on the communication network 102 side even in a case where the transmission of the periodic measurement packet is not performed, and it is possible to maintain the communication even in a case where the IP address of the wireless terminal 100 on the communication network 102 side is changed.

In addition, in a case where the measurement packet is received from the wireless terminal 100, the control unit 14 of the network test device 1b detects an IP address of a transmission source, which is an IP address of the wireless terminal 100 on the communication network 102 side, and transmits the measurement packet to the IP address.

Therefore, the measurement packet is transmitted to the IP address of the transmission source of the measurement packet received from the wireless terminal 100, and it is possible to maintain the communication even in a case where the IP address of the wireless terminal 100 on the communication network 102 side is changed.

In addition, in a case where the control unit 14 of the network test device 1b detects that the IP address of the transmission source of the received measurement packet is changed, the control unit 14 changes the destination address of the measurement packet to be transmitted.

Therefore, in a case where there is a change in the IP address of the transmission source of the measurement packet received from the wireless terminal 100, the destination IP address of the measurement packet to be transmitted is changed, the destination IP address of the measurement packet can be efficiently changed, and even in a case where the IP address of the wireless terminal 100 on the communication network 102 side is changed, the communication can be maintained.

Hitherto, the embodiments of the present invention have been disclosed, but it is clear that changes can be made by those skilled in the art without departing from the scope of the present invention. All such modifications and equivalents are intended to be included in the following claims.

### Second Embodiment

Hereinafter, the network test device according to the embodiment of the present invention will be described in detail with reference to the drawings.

In FIG. 1, a network test device 1 according to an embodiment of the present invention is configured with a transmission and reception unit 11, an operation unit 12, a display unit 13, and a control unit 14.

The transmission and reception unit 11 transmits and receives a packet to and from a device connected by wire or the like according to a predetermined communication standard. The transmission and reception unit 11 transmits the received packet to the control unit 14. The transmission and reception unit 11 transmits a packet created by the control unit 14 according to a predetermined communication standard.

The operation unit 12 is configured with an input device such as a keyboard, a mouse, and a touch panel, and outputs information or the like input by an operation to the control unit 14.

The display unit 13 is configured with an image display device, such as a liquid crystal display, and displays an image for inputting information required for measurement, an image indicating a measurement result, or the like.

The control unit 14 is configured with a computer unit including a central processing unit (CPU), a random access memory (RAM), a read only memory (ROM), a hard disk device, and an input and output port (not illustrated).

The ROM and the hard disk device of this computer unit store various control constants, various maps, and the like, as well as a program for causing the computer unit to function as the control unit 14. That is, the computer unit functions as the control unit 14 by the CPU executing the program stored in the ROM and the hard disk device. The hard disk device may be a compact flash (CF) card or the like using a flash memory.

The transmission and reception unit 11, the operation unit 12, and the display unit 13 are connected to the input and output port of the control unit 14, and the control unit 14 and each unit can transmit and receive a signal.

In the present embodiment, in the same manner as a network test device 1c in FIG. 2, the network test device 1 in FIG. 1 is connected to a wireless terminal 100, which is a device under test (DUT), and causes the wireless terminal 100 to transmit and receive a packet to and from a server connected to a communication network 102 via a base station 101 for testing network performance of the wireless terminal 100.

The network test device 1c causes the wireless terminal 100 to transmit the packet to the server by using, for example, a tethering function of the wireless terminal 100.

In addition, in the same manner as a network test device 1d in FIG. 2, the network test device 1 in FIG. 1 can also function as a server facing the wireless terminal 100, and can be connected to the communication network 102 to transmit and receive a packet to and from the wireless terminal 100.

The network test device 1c performs a test for measuring a throughput, a delay, or the like of a downlink, which is a flow of a packet from the server to the wireless terminal 100.

The network test device 1d performs a test for measuring, for example, a throughput, a delay, or the like of an uplink, which is a flow of the packet from the wireless terminal 100 to the server.

At the time of measurement, the measurement packet is transmitted by designating an address of a destination, for example, an Internet Protocol (IP) address. The IP address is an IP address in the communication network 102. In a case where communication is performed between the network test device 1c and the wireless terminal 100 by using an IP address, communication is performed by using an IP address distinguished from the IP address.

In a case where the network test device 1c transmits the packet to the IP address of the server in the communication network 102, the packet reaches the server through the wireless terminal 100. In this case, a transmission source of the packet is an IP address of the wireless terminal 100 on the communication network 102 side. That is, the wireless terminal 100 rewrites the IP address of the transmission source, and the IP address of the wireless terminal 100 on the communication network 102 side is transmitted to the server as the transmission source.

In a case where the network test device 1d transmits the packet to the IP address of the wireless terminal 100 in the communication network 102, the packet reaches the network test device 1c through the wireless terminal 100. That is, the wireless terminal 100 rewrites a destination IP address, and the packet is transmitted to the network test device 1c.

The IP address of the wireless terminal 100 in the communication network 102 is assigned from the communication network 102 and may be changed each time a test is performed. Therefore, it is necessary to check the IP address of the wireless terminal 100 in the communication network 102 each time the test is performed.

In the present embodiment, in a case where the measurement of the downlink is started, the control unit 14 of the network test device 1c first transmits the measurement packet to the server via the wireless terminal 100. Therefore, a measurement packet having the IP address on the communication network 102 side of the wireless terminal 100 as a transmission source is transmitted to the server.

In a case where the measurement packet is received from the wireless terminal 100, the control unit 14 of the network test device 1d as a server detects the IP address of the transmission source, which is an IP address of the wireless terminal 100 on the communication network 102 side, starts the transmission of the measurement packet to the IP address, and starts the downlink measurement.

In a case where the uplink and the downlink are simultaneously measured, the control unit 14 of the network test device 1c starts transmission of a measurement packet for uplink measurement to start the measurement.

In a case where the uplink and the downlink are simultaneously measured, the control unit 14 of the network test device 1d starts the transmission of the measurement packet for the downlink measurement and starts the measurement at a timing at which the measurement packet for the uplink measurement is received from the wireless terminal 100.

In a case where the control unit 14 of the network test device 1d detects that the IP address of the transmission source of the received measurement packet is changed while the uplink and the downlink are being simultaneously measured, the control unit 14 may change the destination IP address of the measurement packet to be transmitted.

A downlink measurement start process by the network test device 1d according to the present embodiment configured as described above will be described with reference to FIG. 3B. The downlink measurement start process to be described below is started in a case where measurement of a downlink is instructed.

In step S1, the control unit 14 of the network test device 1d determines whether or not a measurement packet is received.

In a case where it is determined that the measurement packet is received, the control unit 14 of the network test device 1d executes the process in step S2. In a case where it is determined that the measurement packet is not received, the control unit 14 of the network test device 1d executes the process in step S1.

In step S2, the control unit 14 of the network test device 1d detects a transmission source address of the received measurement packet. After the process in step S2 is executed, the control unit 14 of the network test device 1d executes the process in step S3.

In step S3, the control unit 14 of the network test device 1d starts the transmission of the measurement packet in which the detected transmission source address is set to the transmission destination address, and starts the measurement of the downlink. After executing the process in step S3, the control unit 14 of the network test device 1d ends the downlink measurement start process.

As described above, in the embodiment described above, in a case where the measurement packet is received, the control unit 14 of the network test device 1d detects an IP address of the transmission source of the measurement packet, and starts the transmission of the measurement packet to the IP address to start the downlink measurement.

Therefore, in a case where the measurement packet is received from the wireless terminal 100, the measurement packet is transmitted to the IP address of the transmission source of the received measurement packet, and the downlink measurement is started. Therefore, it is possible to perform the downlink test without checking the IP address of the wireless terminal 100.

In addition, in a case where the control unit 14 of the network test device 1d detects that the IP address of the transmission source of the received measurement packet is changed while the uplink and the downlink are being simultaneously measured, the control unit 14 changes the destination address of the measurement packet to be transmitted.

Therefore, in a case where there is a change in the IP address of the transmission source of the measurement packet received from the wireless terminal 100, the destination IP address of the measurement packet to be transmitted is changed, and even in a case where the IP address of the wireless terminal 100 on the communication network 102 side is changed, the communication can be maintained.

In addition, the control unit 14 of the network test device 1c transmits the measurement packet to the network test device 1d as a server at the start of the downlink measurement.

Therefore, the measurement packet is transmitted to the network test device 1d as the server at the start of the downlink measurement. Therefore, the server that receives the measurement packet can know the IP address of the wireless terminal 100, and the downlink test can be performed without checking the IP address of the wireless terminal 100.

In addition, in a case where the uplink and the downlink are simultaneously measured, the control unit 14 of the network test device 1c starts the transmission of the measurement packet for the uplink measurement to start the measurement.

Therefore, in a case where the uplink and the downlink are simultaneously measured, the measurement is started by the transmission of the measurement packet from the network test device 1c. Therefore, the server that receives the measurement packet for the uplink measurement can know the IP address of the wireless terminal 100, and the downlink test can be performed without checking the IP address of the wireless terminal 100.

Hitherto, the embodiments of the present invention have been disclosed, but it is clear that changes can be made by those skilled in the art without departing from the scope of the present invention. All such modifications and equivalents are intended to be included in the following claims.

### DESCRIPTION OF REFERENCE NUMERALS AND SIGNS

1, 1a, 1b, 1c, 1d: network test device
11: transmission and reception unit
12: operation unit
13: display unit
14: control unit
100: wireless terminal
101: base station
102: communication network

What is claimed is:

1. A network test device that tests network performance of a wireless terminal connected to a communication network via a base station, the network test device comprising:
a control unit that causes the wireless terminal connected to the communication network to transmit a measurement packet including an address of a transmission source.

2. The network test device according to claim 1,
wherein the control unit of the network test device causes the wireless terminal to periodically transmit the measurement packet to a server connected to the communication network, for testing a downlink, which is a flow of a packet from the server to the wireless terminal.

3. The network test device according to claim 2,
wherein the control unit of the network test device detects that an address of the wireless terminal on a communication network side is changed, and causes the wireless terminal to transmit the measurement packet to the server only upon the detection.

4. The network test device according to claim 2,
wherein in a case where an uplink, which is a flow of a packet from the wireless terminal to the server, and the downlink are simultaneously tested, the control unit of the network test device causes the wireless terminal not to transmit the periodic measurement packet.

5. The network test device according to claim 1,
wherein in a case where the measurement packet is received from the wireless terminal, the control unit of the network test device detects the address of the transmission source of the measurement packet, and transmits the measurement packet to the address.

6. The network test device according to claim 5,
wherein in a case where a change in the address of the transmission source of the received measurement packet is detected, the control unit of the network test device changes a destination address of the measurement packet to be transmitted.

7. The network test device according to claim 1,
wherein in a case where the measurement packet is received from the wireless terminal, the control unit of the network test device detects the address of the transmission source of the measurement packet, and starts a test of a downlink, which is a flow of a packet from the network test device to the wireless terminal, by starting transmission of the measurement packet to the address.

8. The network test device according to claim 7,
wherein in a case where an uplink, which is a flow of a packet from the wireless terminal to the network test device, and the downlink are simultaneously tested, and a change in the address of the transmission source of the received measurement packet is detected, the control unit of the network test device changes a destination address of the measurement packet to be transmitted.

9. The network test device according to claim 1,
wherein the control unit of the network test device causes the wireless terminal to transmit the measurement packet to a server connected to the communication network at a start of testing a downlink, which is a flow of a packet from the server to the wireless terminal.

10. The network test device according to claim 9,
wherein in a case where an uplink, which is a flow of a packet from the wireless terminal to the server, and a downlink are simultaneously tested, the control unit of the network test device starts measurement by starting transmission of the measurement packet for uplink measurement.

11. A network test method using a network test device that tests network performance of a wireless terminal connected to a communication network via a base station, the network test method comprising:
a step of causing the wireless terminal connected to the communication network to transmit a measurement packet.

12. The network test method using the network test device according to claim 11, further comprising:
a step of causing the wireless terminal to periodically transmit the measurement packet to a server connected to the communication network, for testing a downlink, which is a flow of a packet from the server to the wireless terminal.

13. The network test method according to claim 12,
wherein it is detected that an address of a wireless terminal on a communication network side is changed, and the wireless terminal is caused to transmit the measurement packet to the server only upon the detection.

14. The network test method according to claim 12,
wherein in a case where an uplink, which is a flow of a packet from the wireless terminal to the server, and the downlink are simultaneously tested, the wireless terminal is caused not to transmit the periodic measurement packet.

15. The network test method using the network test device according to claim 11, further comprising:
a step of detecting, in a case where the measurement packet is received from the wireless terminal, the address of the transmission source of the measurement packet, and transmitting the measurement packet to the address.

16. The network test method using the network test device according to claim 11, further comprising:
a step of detecting, in a case where the measurement packet is received from the wireless terminal, the address of the transmission source of the measurement packet, and starting a test of a downlink, which is a flow of a packet from the network test device to the wireless terminal, by starting transmission of the measurement packet to the address.

17. The network test method according to claim 16,
wherein in a case where an uplink, which is a flow of a packet from the wireless terminal to the network test device, and the downlink are simultaneously tested, and a change in the address of the transmission source of the received measurement packet is detected, a destination address of the measurement packet to be transmitted is changed.

18. The network test method according to claim 11,
wherein the wireless terminal is caused to transmit the measurement packet to a server connected to the communication network at a start of testing a downlink, which is a flow of a packet from the server to the wireless terminal.

19. The network test method according to claim 18,
wherein in a case where an uplink, which is a flow of a packet from the wireless terminal to the server, and a downlink are simultaneously tested, the control unit of the network test device starts measurement by starting transmission of the measurement packet for uplink measurement.
